(19) United States
(12) Patent Application Publication
(10) Pub. No.: US 2024/0067192 A1
(43) Pub. Date: Feb. 29, 2024

(54) PARAMETER UPDATE DEVICE AND PARAMETER UPDATE METHOD

(71) Applicant: ISUZU MOTORS LIMITED, Tokyo (JP)

(72) Inventors: Motoya SUZUKI, Fujisawa-shi (JP); Shuuichi YAHAGI, Fujisawa-shi (JP)

(21) Appl. No.: 18/366,309

(22) Filed: Aug. 7, 2023

(30) Foreign Application Priority Data
Aug. 25, 2022 (JP) 2022-134322

(51) Int. Cl. B60W 50/02; B60W 50/04

(52) U.S. Cl. CPC B60W 50/0225; B60W 50/045; B60W 2050/0075

(57) ABSTRACT

In a control system including a feedback controller, a nominal model, and an error compensator, a parameter update device that updates a parameter of the error compensator 1 includes a data acquisition part that acquires input data indicating a control input to a control object and output data indicating an output from the control object, a reference signal acquisition part that finds a pseudo reference signal, which is a control target value, using the input data and the output data, and a parameter update part that updates the parameter of the error compensator by minimizing an evaluation function defined by the pseudo reference signal.

### CROSS-REFERENCE TO RELATED APPLICATIONS

The present application claims priority to Japanese Patent Applications number 2022-134322, filed on Aug. 25, 2022 contents of which are incorporated herein by reference in their entirety.

### BACKGROUND OF THE INVENTION

The present disclosure relates to a parameter update device and a parameter update method for updating a parameter of an error compensator. The use of a feedback controller on the basis of a nominal model based on the mass of a vehicle to be controlled has been considered as a speed control method for controlling the speed of a vehicle (for example, see Japanese Unexamined Patent Application Publication No. 2017-157121).

However, there is a model error between a nominal model and an actual vehicle due to driving resistance, a gradient of a road on which the vehicle travels, or the like. And due to the influence of the model error, a feedback controller based on the nominal model is sometimes unable to achieve the desired response control. For example, a desired vehicle speed may not be achieved when the vehicle speed of a vehicle is feedback-controlled.

### BRIEF SUMMARY OF THE INVENTION

The present disclosure focuses on this point, and an object thereof is to suppress the influence of a model error in feedback control based on a nominal model.

A first aspect of the present disclosure provides a parameter update device for updating a parameter of an error compensator in a control system including a feedback controller for outputting a control input on the basis of an output of a control object and a target value, and an error compensator for correcting the control input to the control object in order to suppress a model error of a nominal model modeling the control object, the parameter update device includes a first acquisition part that acquires input data indicating the control input to the control object and output data indicating the output from the control object, a second acquisition part that acquires a pseudo reference signal, which is a control target value, using the input data and the output data, and an update part that updates the parameter of the error compensator by minimizing an evaluation function defined by the pseudo reference signal.

A second aspect of the present disclosure provides a parameter update method for updating a parameter of an error compensator in a control system including a feedback controller for outputting a control input on the basis of an output of a control object and a target value, and an error compensator for correcting a control input to the control object in order to suppress a model error of a nominal model modeling the control object, the parameter update method includes the steps of acquiring input data indicating the control input to the control object and output data indicating the output from the control object, acquiring a pseudo reference signal, which is a control target value, using the input data and the output data, and updating the parameter of the error compensator by minimizing an evaluation function defined by the pseudo reference signal.

### BRIEF DESCRIPTION OF THE DRAWINGS

FIG. 1 is a block diagram showing a configuration of a vehicle speed control system 100.

FIG. 2A is graphs showing a simulation result.

FIG. 2B is graphs showing a simulation result.

FIG. 3 schematically shows an example of a configuration of a parameter update device 1.

FIG. 4 is a flowchart showing processing executed by the parameter update device 1.

### DETAILED DESCRIPTION OF THE INVENTION

Hereinafter, the present disclosure will be described through exemplary embodiments of the present disclosure, but the following exemplary embodiments do not limit the disclosure according to the claims, and not all of the combinations of features described in the exemplary embodiments are necessarily essential to the solution means of the disclosure.

### <Overview of Parameter Updating in Vehicle Speed Control System>

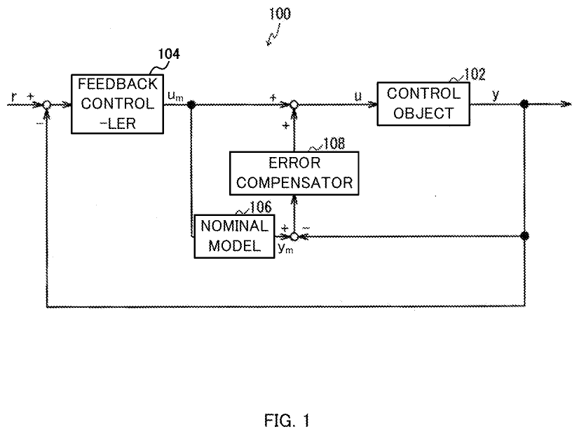

Parameter updating in a vehicle speed control system according to the present disclosure will be described with reference to FIG. 1.

FIG. 1 is a block diagram showing a configuration of a vehicle speed control system 100. The vehicle speed control system 100 is a closed-loop control system that performs feedback control. As shown in FIG. 1, the vehicle speed control system 100 includes a control object 102, a feedback controller 104, a nominal model 106, and an error compensator 108. It should be noted that it is assumed that the functions of the feedback controller 104, the nominal model 106, and the error compensator 108 are implemented by reading a program stored in a storage 20, described later, and executing the program with a controller 30. It should be noted that the functions of the feedback controller 104, the nominal model 106, and the error compensator 108 may be executed by a storage and a controller that are different from the storage 20 and the controller 30.

The control object 102 is a vehicle here. The control object 102 has a driving force, which is a control input u, inputted thereto. Further, the vehicle speed is outputted as an output y from the control object 102 to which the driving force is inputted.

The feedback controller 104 outputs a control input uₘ to the control object 102 by performing feedback control based on the output y of the control object 102. The feedback controller 104 determines the control input uₘ such that a deviation between a target value r and the output y becomes smaller, and outputs the control input uₘ. For example, the output y of the control object 102 is the speed (vehicle speed) of the control object 102. The feedback controller 104 performs the feedback control on the basis of the vehicle speed (output y) and the target speed (target value r).

The nominal model 106 is a model of the control object 102 that contains no uncertainty. The nominal model 106 is a model based only on the mass of the control object 102, and is represented as in Equation (1).

$${P}_{m} = \frac{1}{Ms} \qquad ( 1 )$$

In Equation (1), Pₘ is a transfer function of the nominal model 106, M is the mass of the vehicle, and s is a variable of the Laplace transform.

As the nominal model 106 is a model based only on the mass, there is a model error between the nominal model 106 and the actual vehicle, which is the control object 102. The model error is caused by a travel resistance (for example, rolling resistance or air resistance), a road gradient, or the like. Such a model error makes it difficult to achieve a desired control response in the feedback control. In contrast, in order to suppress the influence of the model error, the vehicle speed control system 100 according to the embodiment is provided with the error compensator 108 and automatically updates a parameter of the error compensator 108.

The error compensator 108 outputs a correction value for correcting the control input uₘ outputted from the feedback controller 104. The control input u to be inputted to the control object 102 is determined on the basis of the correction value and the control input uₘ. The error compensator 108 determines the correction value for correcting the control input uₘ outputted from the feedback controller 104 on the basis of an output error between the output yₘ of the nominal model 106 and the output y of the control object 102. The error compensator 108 includes an adjustable control parameter (simply referred to as a parameter) ρ.

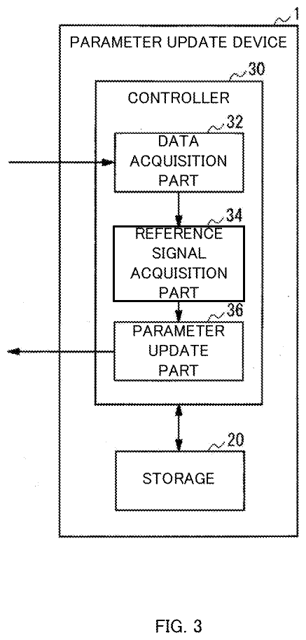

In the vehicle speed control system 100 according to the embodiment, the parameter update device 1 (FIG. 3) updates the parameter ρ of the error compensator 108. The configuration of the parameter update device 1 will be described later. Here, it is assumed that a transfer function C of the control object 102 is represented as in Equation (2).

$$C = \frac{{T}_{d}}{( 2 - {T}_{d} ) {P}_{m}} \qquad ( 2 )$$

In Equation (2), T_{d} is a reference model. The reference model T_{d} is a model designed by a designer in consideration of a desired response speed, the influence of noise, and the like.

In order to update the parameter p, the parameter update device 1 first acquires driving force data u₀, which is input data indicating the control input to the control object 102, and vehicle speed data y₀, which is output data indicating the output from the control object 102. The driving force data u₀ and the vehicle speed data y₀ are time series data over a predetermined period of time (for example, 10 seconds) during which the vehicle is travelling, respectively.

In the embodiment, FRIT (Fictitious Reference Iterative Tuning), which is data-driven controller tuning, is applied to update the parameter ρ of the error compensator 108 using the driving force data u₀ and the vehicle speed data y₀, which are a set of time series data.

Specifically, the parameter update device 1 finds a pseudo reference signal as a target value. The pseudo reference signal is represented as in Equation (3).

$$r ( ρ ) = {C}^{- 1} ( \frac{D ( ρ )}{1 + {P}_{m} D ( ρ )} {y}_{0} + \frac{1}{1 + {P}_{m} D ( ρ )} {u}_{0} ) + {y}_{0} \qquad ( 3 )$$

In Equation (3), D is the transfer function of the error compensator 108.

Next, the parameter update device 1 uses the found pseudo reference signal and the reference model T_{d} to find an evaluation function J represented as in Equation (4).

J=∥y₀−T_{d}f(ρ)∥ (4)

The parameter update device 1 acquires the parameter ρ that minimizes the evaluation function J. The parameter ρ of the error compensator 108 is updated to the acquired parameter ρ. This enables a parameter ρ that can achieve a desired response of the reference model T_{d} to be found. It should be noted that the evaluation function J is minimized by a least squares method, for example.

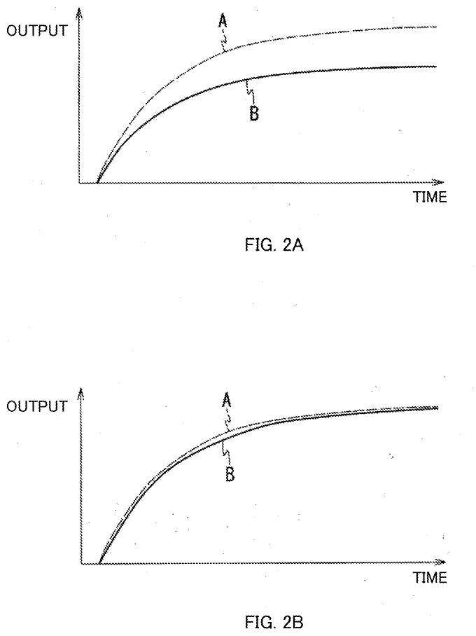

FIGS. 2A and 2B are graphs showing simulation results. A broken line A indicates the target value, and a solid line B indicates an output value.

FIG. 2A shows a simulation result of a comparative example. In the comparative example, the nominal model is used, but unlike the embodiment, no error compensator 108 is provided. In the comparative example, the output value (vehicle speed) deviates from the target value (target speed) as shown in FIG. 2A due to the influence of the model error of the nominal model, and the desired response control is not achieved.

FIG. 2B shows a simulation result of the embodiment. In the embodiment, since the error compensator 108 suppresses the influence of the model error such as the travel resistance when the vehicle is traveling, the output value (vehicle speed) indicates a value close to the target value (target speed) as shown in FIG. 2B, and the desired response control is achieved.

### <Configuration of Parameter Update Device>

The configuration of the parameter update device 1 for updating the parameter ρ of the error compensator 108 will be described with reference to FIG. 3.

FIG. 3 schematically shows an example of the configuration of the parameter update device 1. The parameter update device 1 is mounted on the vehicle here. As shown in FIG. 3, the parameter update device 1 includes the storage 20 and the controller 30.

The storage 20 includes a Read Only Memory (ROM) for storing a Basic Input Output System (BIOS) and the like of a computer, and a Random Access Memory (RAM) serving as a work area. Further, the storage 20 is a large-capacity storage device such as a Hard Disk Drive (HDD) or a Solid State Drive (SSD) that stores an Operating System (OS), an application program, and various types of information referred to when executing the application program.

The controller 30 is a processor such as a Central Processing Unit (CPU) or a Graphics Processing Unit (GPU). The controller 30 functions as a data acquisition part 32, a reference signal acquisition part 34, and a parameter update part 36 by executing the program stored in the storage 20. It should be noted that, in the embodiment, the data acquisition part 32 corresponds to a first acquisition part, the reference signal acquisition part 34 corresponds to a second acquisition part, and the parameter update part 36 corresponds to an update part.

The data acquisition part 32 acquires the input data indicating the control input to the control object 102 and the output data indicating the output from the control object 102. Specifically, the data acquisition part 32 acquires the driving force data indicating the driving force of the vehicle as the input data, and acquires the vehicle speed data indicating the vehicle speed of the vehicle as the output data. The driving force data and the vehicle speed data are data obtained by having the driving force and vehicle speed detected by a detection part such as a sensor provided in the vehicle over a predetermined period of time (for example, 10 seconds).

The data acquisition part 32 acquires the driving force data and the vehicle speed data when the vehicle is traveling before stopping. The driving force data and the vehicle speed data are stored in the storage 20 during traveling of the vehicle, for example, and the data acquisition part 32 acquires the driving force data and the vehicle speed data stored in the storage 20.

The data acquisition part 32 acquires the input data and the output data if a difference between the target value and the output of the control object 102 is larger than a predetermined threshold value. Specifically, the data acquisition part 32 acquires the driving force data and the vehicle speed data if the difference (hereinafter also referred to as a speed difference) between the target speed and the vehicle speed is larger than the predetermined threshold value. If the speed difference is larger than the threshold value, it is determined that the desired response control is not achieved, and the data acquisition part 32 acquires the driving force data and the vehicle speed data to update the parameter ρ of the error compensator 108. It should be noted that the threshold value may vary for each target speed, and for example, the larger the target speed, the larger the threshold value.

The reference signal acquisition part 34 acquires the pseudo reference signal, which is a control target value, using the driving force data and the vehicle speed data acquired by the data acquisition part 32. Specifically, the reference signal acquisition part 34 finds the pseudo reference signal represented by Equation (3) described above. That is, the reference signal acquisition part 34 finds the pseudo reference signal using the nominal model 106, the error compensator 108, the driving force data, and the vehicle speed data.

The parameter update part 36 updates the parameter ρ of the error compensator 108. The parameter update part 36 updates the parameter ρ when the vehicle serving as the control object 102 is stopped. The parameter update part 36 updates the parameter ρ of the error compensator 108 by minimizing the evaluation function defined by the pseudo reference signal found by the reference signal acquisition part 34.

Specifically, the parameter update part 36 first finds the minimum value of the evaluation function J represented by Equation (4) described above. In other words, the parameter update part 36 finds the minimum value of the evaluation function J that is defined by i) the reference model designed to have a desired response characteristic and ii) the pseudo reference signal. By finding the minimum value of the evaluation function J, the optimum value of the parameter ρ is found. The parameter update part 36 updates the found optimal value as the parameter ρ of the error compensator 108.

It should be noted that, in the above description, the parameter update device 1 is provided in the vehicle, but is not limited thereto. For example, the parameter update device 1 may be provided in an external server, and update the parameter ρ of the error compensator 108 using the driving force data and the vehicle speed data received from the vehicle.

### <Flow of Parameter Update>

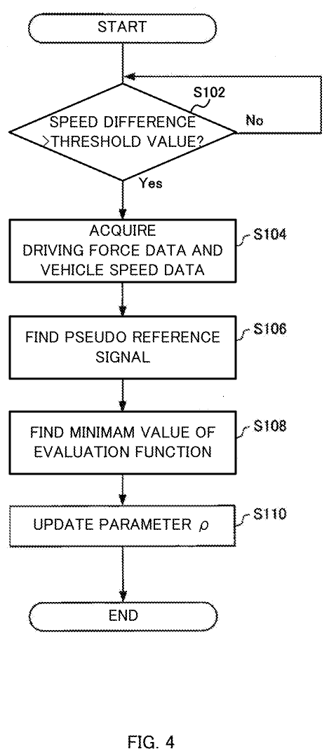

The flow of updating the parameter ρ of the error compensator 108 will be described with reference to FIG. 4.

FIG. 4 is a flowchart showing processing executed by the parameter update device 1.

The flowchart of FIG. 4 starts when the traveling vehicle stops. First, the parameter update device 1 determines whether or not the speed difference between the target speed and the vehicle speed is greater than the predetermined threshold value while the vehicle is traveling before the stop (step S102).

If the speed difference is larger than the threshold value in step S102 (Yes), the data acquisition part 32 acquires the driving force data and the vehicle speed data over the predetermined period of time (step S104). That is, the data acquisition part 32 acquires the driving force data and the vehicle speed data that are a set of time series data.

Next, the reference signal acquisition part 34 finds the pseudo reference signal as the control target value on the basis of the acquired driving force data and vehicle speed data (step S106). For example, the reference signal acquisition part 34 finds the pseudo reference signal represented by Equation (3).

Next, the parameter update part 36 finds the minimum value of the evaluation function based on the found pseudo reference signal and the reference model (step S108). For example, the parameter update part 36 finds the minimum value of the evaluation function J represented by Equation (4). By finding the minimum value of the evaluation function J in this manner, the optimum value of the parameter ρ is found.

Next, the parameter update part 36 updates the parameter ρ of the error compensator 108 (step S110). That is, the parameter update part 36 updates the parameter ρ of the error compensator 108 to the optimal value found in step S108. This means that when the vehicle travels again, the updated parameter ρ of the error compensator 108 is used to control the vehicle speed.

### Effects of the Embodiment

The above-described parameter update device 1 of the embodiment acquires the driving force data and the vehicle speed data for the control object 102, and uses the acquired driving force data and vehicle speed data to find the pseudo reference signal that is the control target value. Then, the parameter update device 1 updates the parameter ρ of the error compensator 108 by minimizing the evaluation function defined by the found pseudo reference signal.

By providing the error compensator 108, the nominal model 106 can be used in the feedback control. Further, since the parameter ρ of the error compensator 108 can be automatically updated using a set of the driving force data and the vehicle speed data for the control object 102, the design of the vehicle speed control can be simplified, and the influence of the model error of the nominal model 106 can be suppressed.

The present disclosure has been described above on the basis of the exemplary embodiments. The technical scope of the present disclosure is not limited to the scope explained in the above embodiments, and it is obvious to those skilled in the art that various changes and modifications within the scope of the disclosure may be made. An aspect to which such changes and modifications are added can be included in the technical scope of the present disclosure is obvious from the description of the claims.

1. A parameter update device for updating a parameter of an error compensator in a control system including a feedback controller for outputting a control input on the basis of an output of a control object and a target value, and an error compensator for correcting the control input to the control object in order to suppress a model error of a nominal model modeling the control object, the parameter update device comprising:
a first acquisition part that acquires input data indicating the control input to the control object and output data indicating the output from the control object;
a second acquisition part that acquires a pseudo reference signal, which is a control target value, using the input data and the output data; and
an update part that updates the parameter of the error compensator by minimizing an evaluation function defined by the pseudo reference signal.

2. The parameter update device according to claim 1, wherein
the first acquisition part acquires the input data and the output data if a difference between the target value and the output is larger than a predetermined threshold value.

3. The parameter update device according to claim 1, wherein
the second acquisition part acquires the pseudo reference signal on the basis of a transfer function of the nominal model based on the mass of the control object, a transfer function of the error compensator, the input data, and the output data.

4. The parameter update device according to claim 1, wherein
the update part updates the parameter of the error compensator by minimizing the evaluation function defined by a reference model designed to have a desired response characteristic and the pseudo reference signal.

5. The parameter update device according to claim 4, wherein
the update part updates the parameter of the error compensator by finding a minimum value of the evaluation function defined by a difference between i) a product of the reference model and the pseudo reference signal and ii) the output data.

6. The parameter update device according to claim 1, wherein
the control object is a vehicle, the input data is data indicating a driving force of the vehicle, and the output data is vehicle speed data of the vehicle.

7. The parameter update device according to claim 6, wherein
the update part updates the parameter of the error compensator for correcting the control input in order to suppress the model error caused by a travel resistance of the vehicle.

8. A parameter update method for updating a parameter of an error compensator in a control system including a feedback controller for outputting a control input on the basis of an output of a control object and a target value, and an error compensator for correcting a control input to the control object in order to suppress a model error of a nominal model modeling the control object, the parameter update method comprising the steps of:
acquiring input data indicating the control input to the control object and output data indicating the output from the control object;
acquiring a pseudo reference signal, which is a control target value, using the input data and the output data; and
updating the parameter of the error compensator by minimizing an evaluation function defined by the pseudo reference signal.
